(19) United States
(12) Patent Application Publication
(10) Pub. No.: US 2019/0100869 A1
(43) Pub. Date: Apr. 4, 2019

(54) CARBON AEROGEL COMPOSITE PREPREG

(71) Applicant: AIRBUS OPERATIONS GMBH, Hamburg (DE)

(72) Inventors: Peter Linde, Buxtehude (DE); Bernd Ruppert, Hamburg (DE); Volker Robrecht, Hamburg (DE)

(21) Appl. No.: 16/145,610

(22) Filed: Sep. 28, 2018

(30) Foreign Application Priority Data
Sep. 29, 2017 (DE) 20 2017 105 966.9

(51) Int. Cl. D06M 11/74; C08J 5/06; C08J 5/04; B64D 45/02

(52) U.S. Cl. CPC D06M 11/74; C08J 5/06; D06M 2101/40; B64D 45/02; C08J 5/042

(57) ABSTRACT

A carbon aerogel composite is disclosed. A carbon fiber is coated with a conductive carbon aerogel. An aerospace-vehicle component, aerospace vehicle or aircraft or lighting guard can include carbon fibers coated with a conductive carbon aerogel, strands comprising carbon fiber coated with a conductive carbon aerogel, woven fabrics comprising carbon fiber coated with a conductive carbon aerogel, or nonwoven fabrics comprising carbon fiber coated with a conductive carbon aerogel.

### CROSS-REFERENCE TO RELATED APPLICATION

This application claims priority to German Utility Model No. 20 2017 105 966.9 filed Sep. 29, 2017, the entire disclosure of which is incorporated by reference herein.

### TECHNICAL FIELD

The disclosure herein relates to novel lightning guard materials, especially for use in large aircraft components made of CFRP, for instance an aircraft fuselage.

### BACKGROUND

Modern aircraft may include wings or fuselages made of carbon fiber composite plastics (CFRP). Since these are not capable of tolerating lightning strikes in the same way as metallic fuselages, the use of a metal weave is required to conduct electrical current in the event of a lightning strike. One disadvantage of the lighter and stiffer CFRP composite is lower conductivity for electrical current. Therefore, a mesh of copper or aluminum is mounted on the outside of the CFRP composite skin. The high conductivity of the copper entails an increase in weight of the entire skin. A lighter aluminum mesh has to be thicker than a copper mesh in order to give the same conductivity.

One problem addressed by the disclosure herein is that of providing aids that are capable of repairing fiber composite materials impregnated with thermoplastic matrix material and make the repairs quicker and simpler.

### SUMMARY

In a completely surprising manner to the person skilled in the art, it has now been found that carbon fiber coated with a conductive carbon aerogel remedies the disadvantages of the prior art. It is preferable when such coated carbon fibers are in the form of a strand, woven fabric or nonwoven fabric. The carbon aerogel has much higher conductivity properties than carbon, the effect of which is that the novel carbon fiber gains better conductivity properties than normal CFRP. Carbon aerogels (e.g. aerographite) are extremely light (lighter than air); since it replaces matrix material, the global density is reduced, which leads to lower weight. The disclosure herein also relates to the production of a mesh of carbon fiber ensheathing with carbon aerogel. The carbon fiber prepreg that forms can be embedded into the CFRP structure. The invention can also be used in various other places.

It is preferable when such coated carbon fibers are present in an aircraft component consisting predominantly of carbon fiber composite. It is preferable when the carbon fibers, strands, woven fabrics or nonwoven fabrics are part of the carbon fiber composite. It is thus possible to replace the copper lattice in the composite skin of commercial aircraft. The disclosure herein also encompasses an aerospace vehicle, aircraft or lightning guard for aerospace vehicles comprising carbon fibers, strands, woven fabrics or nonwoven fabrics according to the disclosure herein.

The above-described aspects and further aspects, features and advantages of the disclosure herein can likewise be inferred from the examples in the embodiments that are described hereinafter with reference to the appended drawings.

### BRIEF DESCRIPTION OF THE DRAWINGS

In the example figures of drawings:

FIG. 1 shows a metal lattice in a CFRP composite;

FIG. 2 shows a carbon aerogel-coated carbon fiber;

FIG. 3 shows the production of such ensheathed carbon fibers; and

FIG. 4 shows a layer of carbon fibers with aerogel coating on a CFRP composite.

In the figures, identical reference numerals are used for identical or at least similar elements, components or aspects. It should be noted that embodiments are described in detail hereinafter that are merely illustrative and nonlimiting.

### DETAILED DESCRIPTION

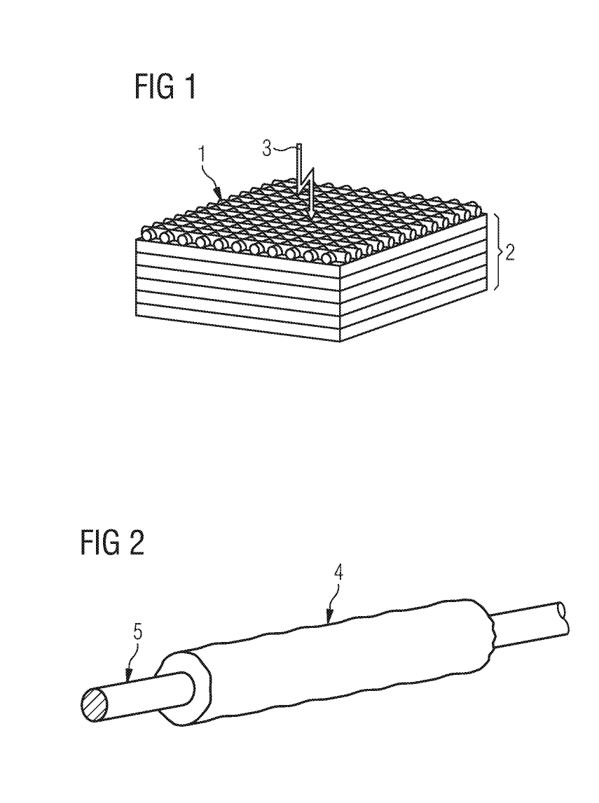

FIG. 1 shows a metal lattice (1) that has been applied to a CFRP composite (2). Such a metal lattice (1) may consist of or comprise copper and is also referred to as copper mesh. It dissipates currents that are caused by a lightning strike (3).

FIG. 2 shows a carbon fiber (5) coated with carbon aerogel (4). The carbon fiber (5) is ensheathed with carbon aerogel (4).

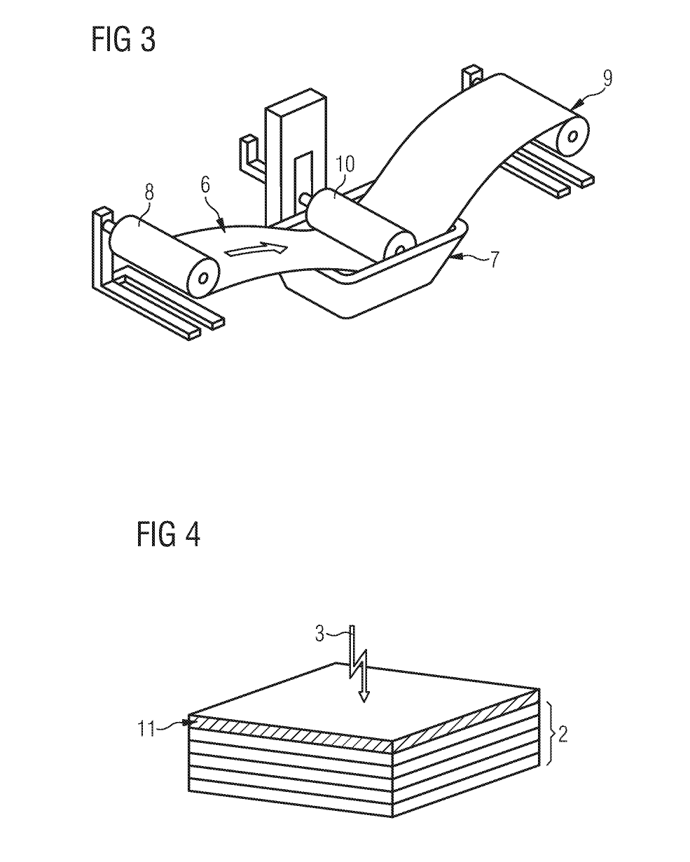

FIG. 3 shows the production of the carbon fibers (5) ensheathed with carbon aerogel (4). The carbon fibers here are moved through a carbon aerogel bath (7) in the form of ribbons or strands (6). The fibers (6) may be prepregs. Untreated carbon fibers may be used in rolled-up form (8). The carbon fiber prepreg with aerogel coating (9) obtained can likewise be obtained in rolled-up form. A roller or cylinder (10) can dip the carbon fibers in the form of ribbons or strands (6) into the carbon aerogel bath (7).

FIG. 4 shows a layer of carbon fibers with aerogel coating (11) that has been applied to a CFRP composite (2). The layer (11) can dissipate currents that are caused by a lightning strike (3). It is possible to provide one or more plies of carbon fibers with aerogel coating as outer layer and apply them with a conventional resin matrix.

While the disclosure herein has been illustrated and described in detail in the drawings and the preceding description, the intention is that such illustrations and descriptions are merely illustrative or exemplary and not restrictive, such that the disclosure herein is not restricted by the embodiments disclosed. In the claims, the word “having” does not exclude other elements and the indeterminate article “a” does not rule out a multitude,

Merely the fact that particular features are mentioned in different dependent claims does not restrict the subject-matter of the disclosure herein. Combinations of these features may also be used advantageously. The reference numerals in the claims are not intended to restrict the scope of the claims.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE NUMERALS

1 Metal lattice

2 CFRP composite

3 Lightning strike

4 Carbon aerogel

5 Carbon fiber

6 Carbon fibers in the form of ribbons or strands

7 Aerogel bath

8 Carbon fiber prepreg

9 Carbon fiber prepreg with aerogel coating

10 Roll or cylinder

11 Layer of carbon fibers with aerogel coating

1. A carbon fiber coated with a conductive carbon aerogel.

2. The carbon fiber according to claim 1, wherein the carbon fiber is in a strand, a woven fabric, or a nonwoven fabric.

3. An aerospace-vehicle component comprising carbon fiber, wherein the carbon fiber is coated with a conductive carbon aerogel.

4. The aerospace-vehicle component according to claim 3, wherein the carbon fiber is in a strand, a woven fabric, or a nonwoven fabric.

5. The aerospace-vehicle component according to claim 4, wherein the component consists predominantly of carbon fiber composite.

6. The aerospace-vehicle component according to claim 5, wherein carbon fibers, strands, woven fabrics or nonwoven fabrics are part of the carbon fiber composite.

7. The aerospace-vehicle component according to claim 5, wherein carbon fibers, strands, woven fabrics or nonwoven fabrics are part of the carbon fiber composite.

8. The aerospace-vehicle component according to claim 3, wherein the component consists predominantly of carbon fiber composite.

9. An aerospace vehicle or aircraft comprising carbon fibers coated with a conductive carbon aerogel, strands comprising carbon fiber coated with a conductive carbon aerogel, woven fabrics comprising carbon fiber coated with a conductive carbon aerogel, or nonwoven fabrics comprising carbon fiber coated with a conductive carbon aerogel.

10. A lightning guard for an aerospace vehicle or aircraft, the lightning guard comprising carbon fibers coated with a conductive carbon aerogel, strands comprising carbon fiber coated with a conductive carbon aerogel, woven fabrics comprising carbon fiber coated with a conductive carbon aerogel, or nonwoven fabrics comprising carbon fiber coated with a conductive carbon aerogel.
